(19) United States
(12) Patent Application Publication
(10) Pub. No.: US 2025/0258766 A1
(43) Pub. Date: Aug. 14, 2025

(54) READ-MODIFY-WRITE MANAGER WITH ARITHMETIC CIRCUIT

(71) Applicant: Texas Instruments Incorporated, Dallas, TX (US)

(72) Inventors: Peijun Hou, GARLAND, TX (US); Denis Beaudoin, Rowlett, TX (US); Joseph Aronson, DALLAS, TX (US)

(21) Appl. No.: 19/053,308

(22) Filed: Feb. 13, 2025

Related U.S. Application Data
(60) Provisional application No. 63/553,186, filed on Feb. 14, 2024.

(51) Int. Cl. G06F 12/02

(52) U.S. Cl. CPC G06F 12/0223

(57) ABSTRACT

In described examples, a device includes first and second memories, an arithmetic pipeline, a write pipeline, and a controller. Update requests include an ADD value and a memory location indicator of the second memory. The first memory receives and stores a first update request at a tail memory location. A read of the second memory is controlled responsive to a read of a second memory location indicator of a second update request from an intermediate memory location of the first memory, and a responsive read data is stored at the intermediate memory location. A third update request and a read data are read from a head memory location of the first memory, and provided to the arithmetic pipeline. The arithmetic pipeline adds the corresponding ADD value and read data to generate a result, which is provided to the write pipeline. The write pipeline responsively generates a write transaction.

### CROSS-REFERENCE TO RELATED APPLICATION

This application claims the benefit of, and priority to, U.S. Provisional Application No. 63/553,186, filed Feb. 14, 2024, which is incorporated herein by reference.

### TECHNICAL FIELD

This application relates generally to network accelerators, and more particularly to read-modify-write (RMW) managers for managing updates of stored network statistics values.

### BACKGROUND

A network-connected integrated circuit, such as a system on a chip (SoC), may include a network accelerator to accelerate transceiver (transmit and receive) participation in the network by the SoC. In turn, the network accelerator may include circuitry to improve transceiver performance by tracking network traffic statistics and adjusting network transceiver behavior responsively. In some examples, this circuitry may include an RMW manager to update stored network statistics information in response to requests from various processor cores of the SoC. Network statistics information includes, for example, a number of packets received in a given time interval, a number of bytes received per packet thread, and a packet size and associated thread's count location.

### SUMMARY

In described examples, a device includes first and second memories, an arithmetic pipeline, a write pipeline, and a controller. Update requests include an ADD value and a memory location indicator of the second memory. The first memory receives and stores a first update request at a tail memory location. A read of the second memory is controlled responsive to a read of a second memory location indicator of a second update request from an intermediate memory location of the first memory, and a responsive read data is stored at the intermediate memory location. A third update request and a read data are read from a head memory location of the first memory, and provided to the arithmetic pipeline. The arithmetic pipeline adds the corresponding ADD value and read data to generate a result, which is provided to the write pipeline. The write pipeline responsively generates a write transaction.

### BRIEF DESCRIPTION OF THE DRAWINGS

FIG. 1 is a functional block diagram of an example SoC that includes a network accelerator with an RMW manager.

FIG. 2 is an example functional block diagram of the RMW manager of FIG. 1.

FIG. 3A is a first flow diagram of an example process for updating statistics information using the RMW manager of FIG. 2.

FIG. 3B is a second flow diagram continuing the example process of FIG. 3A for updating statistics information using the RMW manager of FIG. 2.

FIG. 3C is a third flow diagram continuing the example process of FIGS. 3A and 3B for updating statistics information using the RMW manager of FIG. 2.

FIG. 4 is a flow diagram showing an example process for data forwarding using the RMW manager of FIG. 2.

FIG. 5 is a table of example RMW target interface input/output (I/O) fields for the RMW manager of FIG. 2.

FIG. 6 is a table of example RMW initiator interface I/O fields for the RMW manager of FIG. 2.

### DETAILED DESCRIPTION

An example network processing accelerator core (NPAC) circuit tracks network statistics and responsively controls a system's network interactions, such as by limiting the number of received packets that are admitted for processing in a given time interval in response to a threshold. The threshold is stored in a shared memory, such as a data memory. In an example, the threshold is implemented by a decrementing count from the threshold value responsive to received packets. When a packet is received, a processor in an SoC checks whether a corresponding threshold of the SoC is met. If so, then the received packet is dropped. Otherwise, the packet is forwarded, such as to an application host processor on the SoC or to a network port such as Ethernet or controller area network port. After the threshold comparison, the processor uses a statistics functional block to decrement the threshold if the threshold does not equal zero. The threshold is periodically reset to a default value in response to a timer or other clock-controlled circuit. In some examples, an NPAC or other network controller tracks network statistics values in addition to or other than an admitted packet threshold.

Some SoCs have multiple processors or processor cores that can independently request an update to a statistics value such as the above-described threshold. This type of statistics value is an example of a shared data value that may be frequently accessed (e.g., read or written) by a number of different entities with a high likelihood of conflicts. An RMW manager described herein enables updating such a shared data value without locking (or reducing locking of) the shared memory while maintaining coherency. Avoiding a memory lock requirement and the associated locking circuitry enables some or all of various benefits, such as a reduction in device area cost, increased memory and processing efficiency, reduced power cost, reduced firmware or software program size and/or complexity, and faster data updates.

The same reference numbers or other reference designators are used in the drawings to designate features that are related structurally and/or functionally.

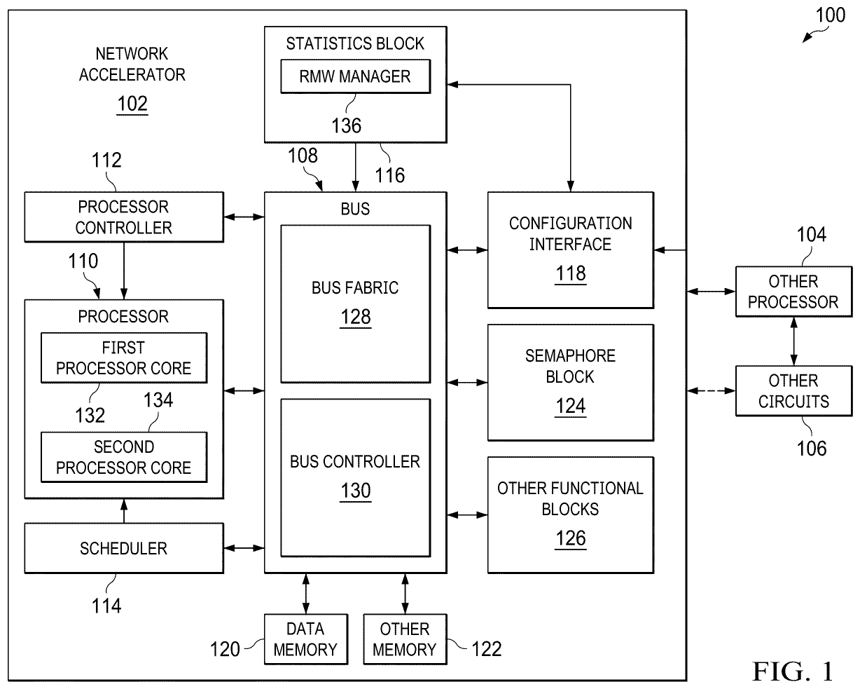

FIG. 1 is a functional block diagram of an example SoC 100 that includes a network accelerator 102. The SoC 100 also includes another processor 104 (other than processor(s) of the network accelerator 102) and other circuits 106 that communicate via the network accelerator 102. The network accelerator 102 includes a bus 108, processor 110, a processor controller 112, a scheduler 114, a statistics block 116, a configuration interface 118, a data memory 120, other memory 122, a semaphore block 124, and other functional blocks 126. In some examples, the other memory 122 includes an instruction memory or one or more lookup tables. In some examples, only processors within the SoC are able to access network statistics tracked responsive to the statistics block 116.

The bus 108 includes a bus fabric 128 and a bus controller 130. The bus fabric 128 corresponds to interconnections between or among various functional blocks of the network accelerator 102. The bus controller 130 determines priority of messages that request use of the bus fabric 128 for transmission to a designated functional block within or outside the network accelerator 102. The processor 110 includes a first processor core 132 and a second processor core 134. In some examples, the processor 110 is a reduced instruction set computing (RISC) processor. The statistics block 116 includes an RMW manager 136.

The other processor 104 is communicatively connected to the network accelerator 102 and to the other circuits 106. In some examples, the other circuits 106 are communicatively connected to the network accelerator 102. The statistics block 116 is communicatively connected to the configuration interface 118. Each of the processor 110, the processor controller 112, the scheduler 114, the configuration interface 118, the data memory 120, the other memory 122, the semaphore block 124, and the other functional blocks 126 is communicatively connected to the bus 108. In particular, the processor 110 and the other processor 104 are connected to communicate with the statistics block 116 via the configuration interface 118. The statistics block 116 is connected to output to the bus 108 (in some examples, via the configuration interface 118). In some examples, for the RMW manager 136, the configuration interface 118 corresponds to a single-issue port to which users write statistics updates via memory mapped registers. In some examples, the configuration interface 118 is part of the statistics block 116. In some examples, the data memory 120 is a shared memory. In some examples, the bus 108 is referred to as a switch central resource (SCR).

The first processor core 132, the second processor core 134, and the other processor 104 are referred to herein as users of the network accelerator 102 and its constituent parts. In some examples, a user uses the semaphore block 124 or other functional blocks 126 (such as a lock circuit dedicated to statistics-related memory access functionality) to lock access to the data memory 120 or other memory 122 (or a portion thereof). Memory access is locked on a first-come-first-served basis to a requesting user while a data access requested by the user, such as a read or write action, is performed. Access lock prevents other users from accessing the locked memory (or portion thereof) while the data access completes. Accordingly, memory accesses prevented by the lock are stalled while the memory access by the user that owns the lock completes. After the memory access directed by the locking user completes, the locking user communicates with the semaphore block 124 to unlock the locked memory. In some examples, memory locking is used to maintain ordering and/or coherency of memory operations. In some examples, different device functionality uses different circuitry to implement a lock, such as different memory and/or different logic circuits.

As described above, a memory lock process takes time, and corresponding hardware uses device area, power, and other device resources. The RMW manager 136 enables ordered RMW operations on memory (such as the data memory 120) used to store network statistics without a lock. These network statistics are only one type of a shared data value that is frequently accessed by a number of different entities (e.g., processor 110, processor 104, etc.) with a high likelihood of conflicts, and the RMW manager 136 is equally suited to manage the accesses of other types of shared data.

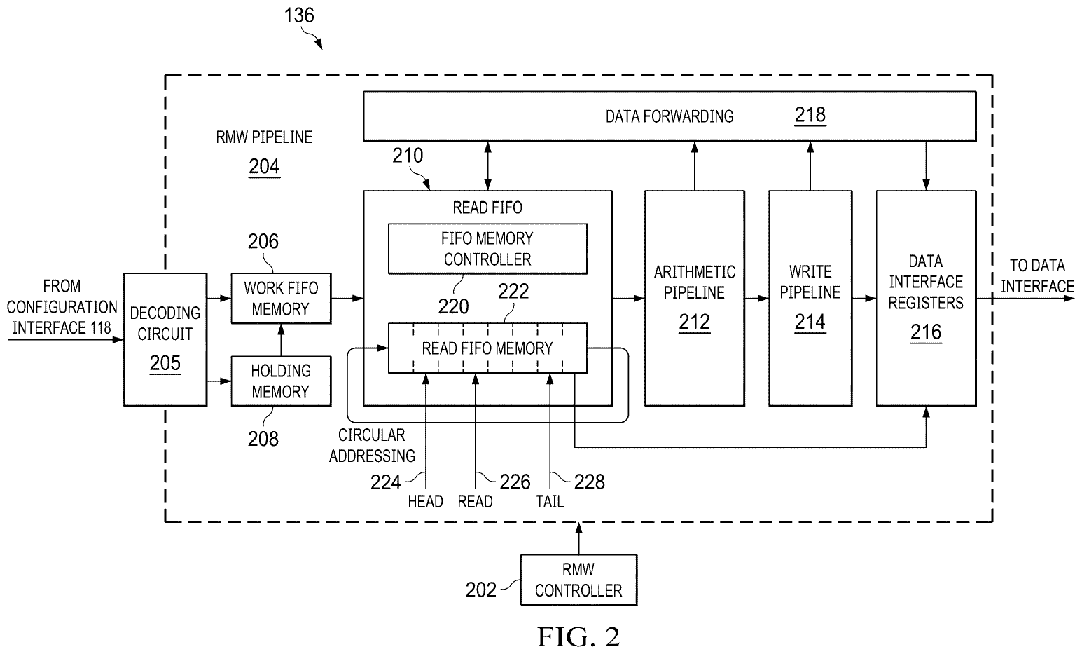

FIG. 2 is an example functional block diagram of the RMW manager 136 of FIG. 1. The RMW manager 136 includes an RMW controller 202 and an RMW pipeline 204. The RMW pipeline 204 includes a decoding circuit 205, a work first-in-first-out (FIFO) memory 206, a holding memory 208, a read FIFO 210, an arithmetic pipeline 212, a write pipeline 214, data interface registers 216, and a data forwarding block 218. Data interface refers to the physical bus that connects the RMW manager 136 to the data memory 120 where statistics values are stored. The read FIFO 210 includes a FIFO memory controller 220 and a read FIFO memory 222. The read FIFO memory 222 uses circular addressing, so that repeatedly incrementing a pointer initially indicating a memory location in the read FIFO memory 222 will cause the pointer to circularly wrap around and eventually indicate the initially indicated memory location. Herein, incrementing a pointer refers to adjusting the pointer to indicate a sequentially next memory location. Note that, in many examples, data is written (added) to the tail of a FIFO queue using a tail pointer 228, and read (removed) from the head of the FIFO queue using a head pointer 224.

The RMW controller 202 is connected to control the RMW pipeline 204. The decoding circuit 205 receives messages, referred to herein as statistics update requests, from the configuration interface 118 (via the bus 108). A statistics update request corresponds to a request from a user to modify a statistics value. In an example, the statistics value is a threshold corresponding to a number of received packets that may be admitted in a specified time interval.

A statistics update request may include a pointer to a target memory location and/or an ADD value. The target memory location stores the statistics value to be modified, and the ADD value is a signed value to be added to the statistics value to generate an updated statistics value. For example, an ADD value of +1 (positive one) or −1 (negative one) corresponds to an increment or decrement operation, respectively. In some examples, users that can send statistics update requests include processor cores (such as the first and second processor cores 132 and 134) within the network accelerator 102, and other processors 104 outside the network accelerator 102 that execute software performing network-related functionality.

If the statistics update request includes both an ADD value and a memory pointer, the decoding circuit 205 passes the statistics update request to the work FIFO memory 206. If the statistics update request includes only one of an ADD value or a memory pointer, the decoding circuit 205 passes the statistics update request to the holding memory 208. This allows the ADD value and memory pointer to be specified in separate requests. For example, a first request may specify the ADD value, and a second request may specify a corresponding memory pointer, or vice-versa.

The holding memory 208 outputs to the work FIFO memory 206. The work FIFO memory 206 outputs to the read FIFO 210. The read FIFO 210 communicates with the data forwarding block 218, and outputs to the arithmetic pipeline 212 and the data interface registers 216. The arithmetic pipeline 212 outputs to the data forwarding block 218 and the write pipeline 214. The write pipeline 214 outputs to the data forwarding block 218 and the data interface registers 216. The data forwarding block 218 outputs to the data interface registers 216. The data interface registers 216 output to the data interface.

A statistics update request includes either or both of an ADD value or a pointer to a location in a shared memory of the network accelerator 102 (a memory pointer) that stores network statistics information, such as the data memory 120. In some examples, reads and writes to memories within the RMW pipeline 204, and compare actions and other data movement within the RMW pipeline 204, are controlled by the RMW controller 202. In some examples, memory controllers within the RMW pipeline 204, including the FIFO memory controller 220, can be described as part of or operating responsive to the RMW controller 202.

The RMW pipeline 204 receives statistics update requests from a requesting user via the configuration interface 118. In some examples, the holding memory 208 includes a memory location corresponding to each user that can provide a statistics update request to the RMW manager 136. If the statistics update request includes only one of an ADD value or a memory pointer, then the statistics update request is written to the location in the holding memory 208 corresponding to the requesting user.

In some examples, one or more status bits are used to indicate whether and/or which locations in the holding memory 208 contain both an ADD value and a memory pointer. Once both an ADD value and a memory pointer corresponding to a requesting user have been written to a location in the holding memory 208, the ADD value and memory pointer are read from the holding memory 208 and written to a tail memory location of the work FIFO memory 206. Alternatively, if the RMW pipeline 204 receives a statistics update request that includes both an ADD value and a memory pointer, then the ADD value and memory pointer are written to the tail memory location of the work FIFO memory 206 without writing to the holding memory 208.

The RMW controller 202 tracks a head pointer 224, a read pointer 226, and a tail pointer 228, that each indicate a different memory location within the read FIFO memory 222. The head pointer 224 indicates the head of the FIFO queue. The tail pointer 228 indicates the tail of the FIFO queue. The read pointer 226 indicates a read FIFO memory 222 location that stores a memory pointer that indicates a data memory 120 (or other memory 122) location storing a statistics value that will be the next value updated (modified) using the ADD value corresponding to the memory pointer. Accordingly, the read FIFO memory 222 is a wraparound window, with newest data at a tail memory location, oldest data at a head memory location, and a read memory location located therebetween.

Each memory location in the read FIFO memory 222 may have several fields, such as a memory pointer field, an ADD value field, a read value field, and a status bit field. The memory pointer field stores a memory pointer that indicates a memory location in the data memory 120 (or other shared memory) that stores a statistics value to be updated. The ADD value field stores an ADD value corresponding to the memory pointer that will be used to modify the statistics value stored at the memory location corresponding to the memory pointer. The read value field stores the statistics value to be modified after it is read from the data memory 120 (described below). The status bit field stores a status bit that indicates whether the read value field stores valid data to be modified.

The status bit can have a VALID value, indicating valid data is stored in the read value field of the read FIFO memory 222 location, or an INVALID (or/VALID) value, indicating valid data is not stored in the read value field of the read FIFO memory 222 location. The status bit field has the INVALID value at the time that the memory pointer and ADD value are written to the read FIFO memory 222 location indicated by the tail pointer 228. The INVALID value of the status field is set contemporaneous with or previous to the initial write of an ADD value and a memory pointer to the read FIFO memory 222 location indicated by the tail pointer 228.

The RMW controller 202 controls the work FIFO memory 206 to retrieve the ADD value and memory pointer stored at a head memory location of the work FIFO memory 206, controls the read FIFO memory 222 to store that ADD value and memory pointer into respective fields at the read FIFO memory 222 location indicated by the tail pointer 228, and increments the tail pointer. (In the illustrated example of FIG. 2, incrementing a memory pointer of the read FIFO memory 222 corresponds to the pointer moving to the right.) The RMW controller 202 controls the read FIFO memory 222 to retrieve the memory pointer stored at the read FIFO memory 222 location indicated by the read pointer 226, and generates a read transaction requesting a memory read of the data memory 120 at a location corresponding to the retrieved memory pointer. The read FIFO memory 222 provides the read transaction to the data interface registers 216 to transmit the read transaction to the data memory 120 via the bus 108. After the data memory 120 returns responsive read data, the read data is stored in the read value field of the read FIFO memory 222 location corresponding to the memory pointer, and the status bit field at that location is set to the VALID value, indicating the presence of valid read data. The RMW controller also increments the read pointer 226.

The RMW controller 202 controls the ADD value, read data, and memory pointer to be read from the location in the read FIFO memory 222 indicated by the head pointer 224 and provided to the arithmetic pipeline 212, and increments the head pointer 224. The arithmetic pipeline 212 performs a mathematical function (e.g., addition or subtraction) on the ADD value and the read data to generate a modified value. The write pipeline 214 generates a write transaction that requests the modified value be written to the location in the data memory 120 corresponding to the memory pointer. The write pipeline 214 provides the write transaction, which includes the modified value and memory pointer, to the data interface registers 216. The write transaction is then read out from the data interface registers 216 and communicated to the data memory 120 via the bus 108. Responsive to the write transaction, the modified value is written to the location of the data memory 120 indicated by the memory pointer.

Herein, reference to information stored in the read FIFO memory 222 refers to information stored in memory locations between (in terms of modulo addressing) and including the memory location indicated by the head pointer 224 and the memory location indicated by the tail pointer 228. The data forwarding block 218 compares memory pointers stored in the read FIFO memory 222 to memory pointers associated with ADD values and corresponding read values proceeding through the arithmetic pipeline 212 or the write pipeline 214. If a memory pointer in the read FIFO memory 222 matches a memory pointer in the arithmetic pipeline 212 or the write pipeline 214 due to a first request and a subsequent request modifying the same value, then the following actions may be performed. First, the modified value associated with the first request and corresponding to the matched memory pointer in the arithmetic pipeline 212 or the write pipeline 214 is copied into the read FIFO memory 222 location corresponding to the matched memory pointer and associated with the subsequent request. Second, the status bit in the read FIFO memory 222 location corresponding to the matched memory pointer is set to VALID. The status bit is set to VALID because the modified value pulled from the arithmetic pipeline 212 or the write pipeline 214 already incorporates a read value previously read from the data memory 120 location corresponding to the memory pointer. Third, the matched memory pointer and corresponding modified value in the arithmetic pipeline 212 or the write pipeline 214 associated with the first request are discarded.

Note that the data memory 120 read corresponding to the matched memory pointer does not have to be performed again because it was performed to generate the modified value associated with the first request that is still in flight. Also note that the modified value will be added to the ADD value corresponding to the matched memory pointer in the read FIFO memory 222 to generate a new modified value that will be written back to the location in the data memory 120 that stores a corresponding statistics value. Accordingly, use of the data forwarding block 218 enhances operating efficiency of the RMW manager 136.

In some examples, the data forwarding block 218 invalidates (discards) the matched memory pointer and corresponding modified value associated with the first request by sending a command to the data interface registers 216 to overwrite a corresponding write transaction with a NULL value, or to set a status flag qualifying the write transaction for transmission to an INVALID value. In some examples, the data forwarding block 218 invalidates the matched memory pointer and corresponding modified value by sending a command to the arithmetic pipeline 212 or the write pipeline 214.

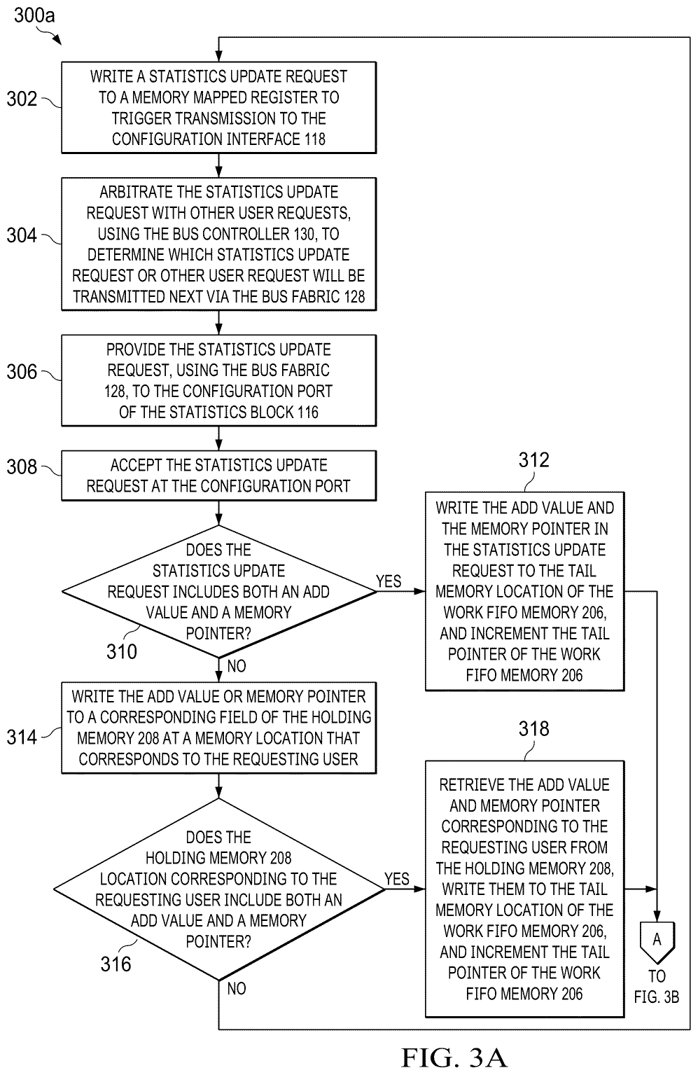

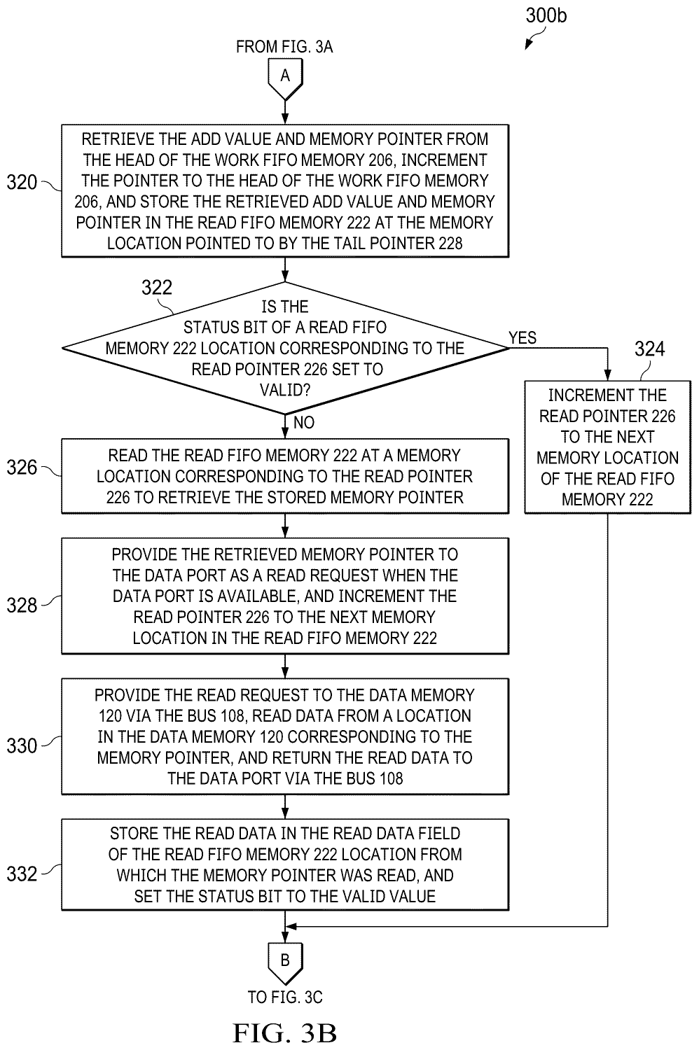

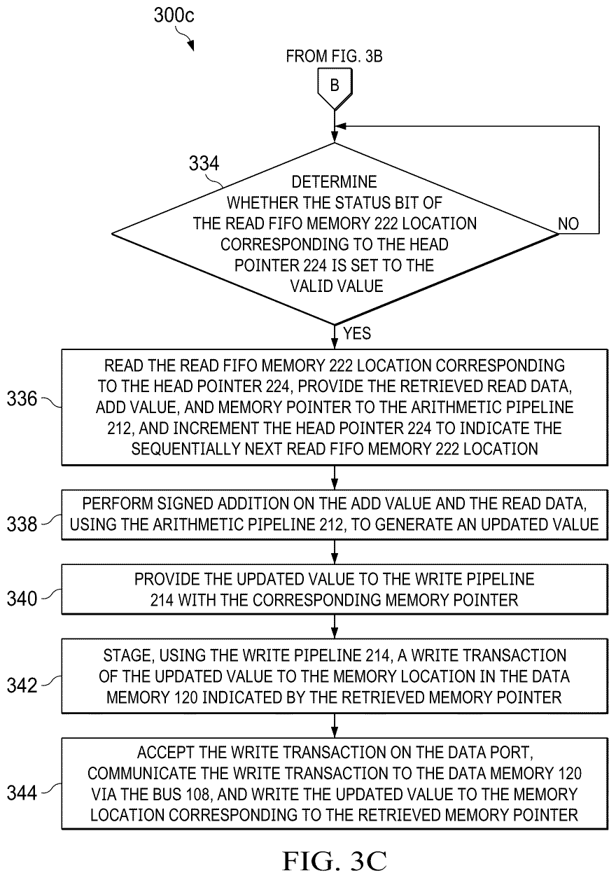

FIG. 3A is a first flow diagram of an example process 300 for updating statistics information using the RMW manager 136 of FIG. 2. FIG. 3A is continued in FIGS. 3B and 3C. FIG. 3A shows a first portion 300a of the process 300, FIG. 3B shows a second portion 300b of the process 300, and FIG. 3C shows a third portion 300c of the process 300. In some examples, the process 300 describes a process for handling a particular statistics update request. Other statistics update requests can be handled by other iterations of the process 300 performed in parallel with the particular statistics update request using the RMW pipeline 204.

In step 302, a requesting user provides a statistics update request to a statistics block 116. In an example, the requesting user writes to a statistics memory mapped register (MMR) associated with the statistics block 116. The statistics update request includes either or both of an ADD value or a pointer to a location in a data memory 120 (or other shared memory). In some examples, the statistics MMR is located in the processor or processor core corresponding to the requesting user. The presence of the statistics update request in the statistics MMR indicates a request to the bus controller 130 to control transmission of the statistics update request to the statistics block 116.

In step 304, the bus controller 130 arbitrates the statistics update request with other user requests to determine which statistics update request or other user request will be transmitted next via the bus fabric 128. In some examples, request priority is determined using a round robin, fixed priority, or other priority determination system. Arbitration by the bus controller 130 may impose an ordering on statistics update requests from the various users so that the RMW manager 136 receives one statistics update request message at a time. In some examples, arbitration is used when multiple users contemporaneously attempt to use the same physical bus interface.

In step 306, the bus fabric 128 provides the statistics update request to the configuration interface 118 corresponding to the statistics block 116. As described above, the configuration interface 118 corresponding to the statistics block 116 is a single-issue port. Accordingly, the bus fabric 128 transmits one request at a time to the RMW manager 136, and the configuration interface 118 receives one request at a time into the RMW manager 136. This enforcement of serial request behavior helps the RMW manager 136 to maintain ordering and/or coherency of statistics-related memory operations as described.

In step 308, the configuration interface 118 accepts the statistics update request. In some examples, the configuration interface 118 may refuse the statistics update request if the work FIFO memory 206 is full and the statistics update request includes both an ADD value and a memory pointer, and/or if the read FIFO memory 222 is full. The statistics update request remains on the bus 108 until the configuration interface 118 accepts it. In some examples, the work FIFO memory 206 becomes full after the read FIFO memory 222 is full. In some examples, if the work FIFO memory 206 is full, then the RMW controller 202 sends a request to the configuration interface 118 to set a READY flag to a NOT_READY value. The RMW controller 202 sends a request to the configuration interface 118 to set the READY flag to a READY value once the work FIFO memory 206 and/or the read FIFO memory 222 have emptied to a specified threshold level. The configuration interface 118 accepts the statistics update request if the READY flag has a READY value, and refuses the statistics update request if the READY flag has the NOT_READY value. As described above, once the READY flag transitions from the NOT_READY value to the READY value, statistics update requests on the bus 108 will be arbitrated by the bus 108 and accepted serially (one at a time) by the configuration interface 118.

In step 310, the RMW controller 202 determines whether the statistics update request includes an ADD value, a memory pointer, or both. In an example, this determination is made by the decoding circuit 205. If the statistics update request includes both an ADD value and a memory pointer, the process 300 proceeds in step 312. If the statistics update request includes only one of an ADD value or a memory pointer, the process 300 proceeds in step 314.

In step 312, the RMW controller 202 controls the ADD value and the memory pointer in the statistics update request to be written to the tail memory location of the work FIFO memory 206, and increments the tail pointer of the work FIFO memory 206. The process 300 then proceeds at step 320.

In step 314, the ADD value or memory pointer is written to a corresponding field (ADD value field or memory pointer field) of the holding memory 208 at a memory location that corresponds to the requesting user. In step 316, the RMW controller 202 determines whether the memory location corresponding to the requesting user includes both an ADD value and a memory pointer, due to, for example, a first request providing an ADD value and a second request providing a corresponding memory pointer, or vice-versa. If both are present, the process 300 continues in step 318. Otherwise, the process 300 returns to step 302.

In step 318, the RMW controller 202 controls the ADD value and memory pointer corresponding to the requesting user to be retrieved from the holding memory 208 and written to the tail memory location of the work FIFO memory 206, and increments the tail pointer of the work FIFO memory 206.

FIG. 3B is a second flow diagram continuing the example process 300 of FIG. 3A for updating statistics information using the RMW manager 136 of FIG. 2. As described above, FIG. 3B shows a second portion 300b of the process 300.

In step 320, the RMW controller 202 retrieves the ADD value and memory pointer from the head of the work FIFO memory 206, increments the pointer to the head of the work FIFO memory 206, and stores the retrieved ADD value and memory pointer in the read FIFO memory 222 at the memory location pointed to by the tail pointer 228. In some examples, the RMW controller 202 waits until the read FIFO memory 222 is available, accordingly, the read FIFO memory 222 is not being read from or written to, before controlling a write to the read FIFO memory 222. In some examples, the RMW controller 202 maintains a list queueing read and write actions to be performed on the read FIFO memory 222.

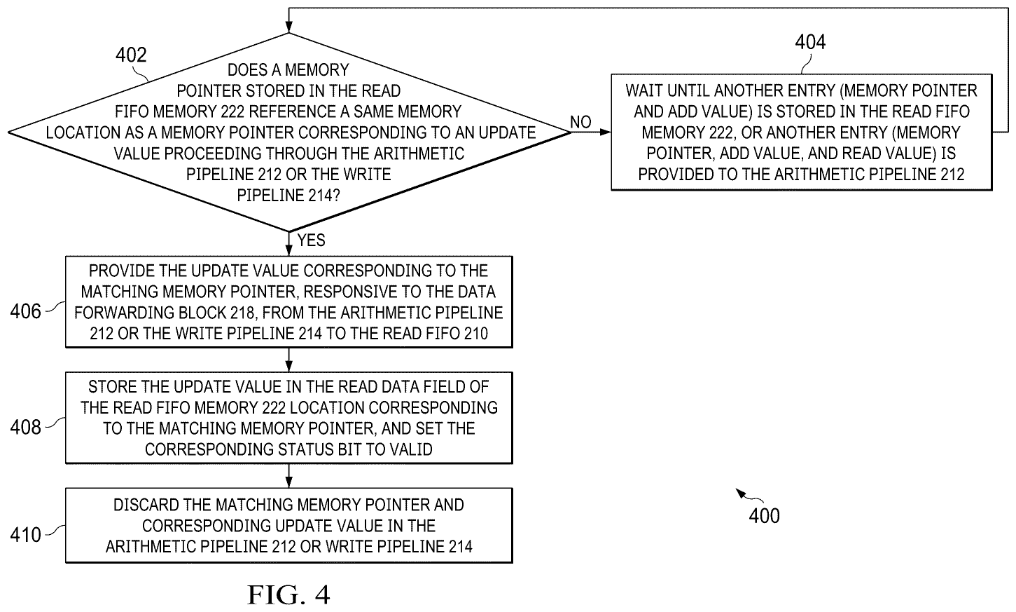

In step 322, the RMW controller 202 determines whether the status bit of a read FIFO memory 222 location corresponding to the read pointer 226 is set to VALID, indicating the read FIFO memory 222 location corresponding to the read pointer 226 stores valid read data. If that status bit is set to VALID, then in step 324, the RMW controller 202 increments the read pointer 226 to the next memory location of the read FIFO memory 222, and the process 300 continues at step 334. The status bit at a read FIFO memory 222 location may be set to VALID prior to step 322 in response to a process 400 for data forwarding determining that a memory pointer in the arithmetic pipeline 212 or in the write pipeline 214 matches the memory pointer stored at the read FIFO memory 222 location. The process 400 for data forwarding is further described with respect to FIG. 4. If the status bit is set to INVALID (indicating the read FIFO memory 222 location corresponding to the read pointer 226 does not yet store valid read data), then the process 300 proceeds at step 326.

In step 326, the RMW controller 202 controls a read of the read FIFO memory 222 at a memory location corresponding to the read pointer 226 to retrieve the stored memory pointer. In step 328, the RMW controller 202 provides the retrieved memory pointer to the data port of the statistics block 116 as a read request when the data port is available. In some examples, a single such read request is pending at a time. In some examples, this constraint is imposed by the single-issue nature of the data port of the RMW manager 136.

In step 330, the read request is accepted by the bus 108 and the data memory 120 and provided to the data memory 120 via the bus 108, data is read from a location in the data memory 120 corresponding to the memory pointer, and the read data is returned via the bus 108 to the data port. In step 332, the RMW controller 202 controls the read data to be stored in the read data field of the read FIFO memory 222 location from which the memory pointer was read, sets the status bit to the VALID value, and increments the read pointer 226 to the next memory location in the read FIFO memory 222.

FIG. 3C is a third flow diagram continuing the example process 300 of FIGS. 3A and 3B for updating statistics information using the RMW manager 136 of FIG. 2. As described above, FIG. 3C shows a third portion 300c of the process 300.

In step 334, the RMW controller 202 determines whether the status bit of the read FIFO memory 222 location corresponding to the head pointer 224 is set to the VALID value. If it is, then the process 300 proceeds at step 336. Otherwise, the step 334 check is repeated until the VALID value is detected. In some examples, the step 334 check may return an INVALID value in response to a delay in step 330 and/or step 332, such as a delay in the step 330 access to the data memory 120. In some examples, operation of the RMW manager 136 may continue, so that other steps of the process 300 may be performed with respect to other statistics update requests, while the process 300 waits for step 330 to detect the VALID value.

In step 336, the RMW controller 202 controls a read of the read FIFO memory 222 location corresponding to the head pointer 224, provides the retrieved read data, ADD value, and memory pointer to the arithmetic pipeline 212, and increments the head pointer 224 to indicate the sequentially next read FIFO memory 222 location. Recall that the retrieved memory pointer was used to retrieve the read data, and corresponds to the statistics value being updated.

In step 338, the arithmetic pipeline 212 performs signed addition on the ADD value and the read data to generate an updated (result) value. In step 340, the RMW controller 202 provides the updated value to the write pipeline 214 with the corresponding retrieved memory pointer.

In step 342, the write pipeline 214 generates a write transaction requesting the updated value be written to the memory location in the data memory 120 indicated by the retrieved memory pointer. When the data port of the statistics block is available, the RMW controller 202 moves the write transaction from the write pipeline 214 to the data port. In step 344, the write transaction is accepted on the data port, the bus 108 communicates the write transaction to the data memory 120, and the updated value is written to the memory location corresponding to the retrieved memory pointer. Data forwarding as described enables more efficient memory use, reduces the number of bus transactions required, reduces power consumption by statistics-related RMW processes, reduces memory and/or bus fabric contention, and enables the network accelerator to handle greater capacity and/or throughput.

FIG. 4 is a flow diagram showing an example process 400 for data forwarding using the RMW manager 136 of FIG. 2. In step 402, the data forwarding block 218 compares memory pointers stored in the read FIFO memory 222 to memory pointers corresponding to modified values proceeding through the arithmetic pipeline 212 or the write pipeline 214. If a memory pointer in the read FIFO memory 222 matches a memory pointer in the arithmetic pipeline 212 or the write pipeline 214, the process 400 proceeds at step 406. Otherwise, in step 404, the process 400 waits until another entry (memory pointer and ADD value) is stored in the read FIFO memory 222, or another entry (memory pointer, ADD value, and read value) is provided to the arithmetic pipeline 212, and then returns to step 402.

In step 406, the data forwarding block 218 provides the modified value corresponding to the matching memory pointer from the arithmetic pipeline 212 or the write pipeline 214 to the read FIFO 210. In step 408, the RMW controller 202 controls the read FIFO memory 222 to store the modified value in the read data field of the read FIFO memory 222 location corresponding to the matching memory pointer, and set the corresponding status bit to VALID. In step 410, the matching memory pointer and corresponding modified value in the arithmetic pipeline 212 or write pipeline 214 is discarded.

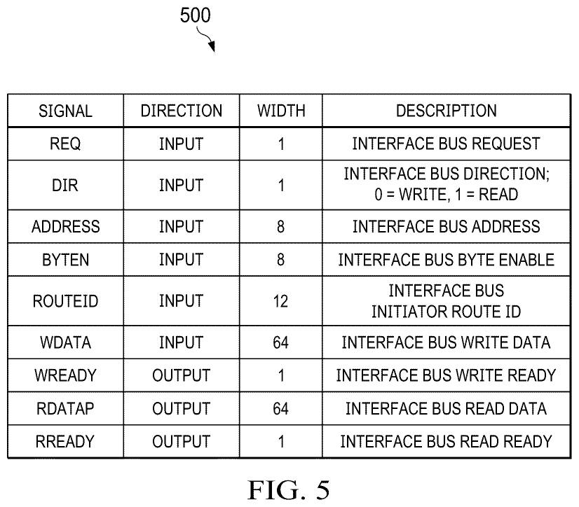

FIG. 5 is a table 500 of example RMW target interface I/O fields for the RMW manager 136 of FIG. 2. These interface I/O fields correspond to the hardware I/O interface for corresponding functional blocks of the network accelerator 102. With respect to interface I/O fields listed in the table 500, the configuration interface 118 of the RMW manager 136 is the target, and the users are initiators. Accordingly, the interface I/O fields listed in the table 500 are used to generate I/O requests that are issued by the users to be executed by the configuration interface 118 of the RMW manager 136. In an example, RMW target interface I/O fields described with respect to the table 500 are used by users to generate statistics update requests that are sent to the RMW manager 136 (via the configuration interface 118) for execution.

A first column 502 indicates an example interface I/O field name, a second column 504 indicates an input or output direction, a third column 506 indicates an example interface I/O field bit width, and a fourth column 508 provides a description of the corresponding interface I/O field. A request (req) field relates to input, has a bit width of one, and indicates an interface bus request. A direction (dir) field relates to input, has a bit width of one, and indicates an interface bus direction. In an example, a zero indicates a write, and a one indicates a read. An address field relates to input, has a bit width of eight, and indicates an interface bus address. A byten field relates to input, has a bit width of eight, and indicates an interface bus byte enable. A routeid field relates to input, has a bit width of twelve, and indicates an interface bus initiator identifier (ID). A wdata field relates to input, has a bit width of 64, and indicates interface bus write data. A wready field relates to output, has a bit width of one, and indicates interface bus write ready. An rdatap field relates to output, has a bit width of 64, and indicates interface bus read data. An rready field relates to output, has a bit width of one, and indicates interface bus read ready.

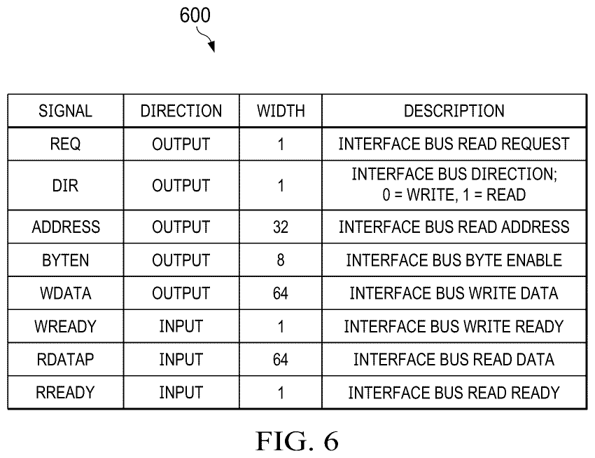

FIG. 6 is a table 600 of example RMW initiator interface I/O fields for the RMW manager 136 of FIG. 2. These interface I/O fields correspond to the hardware I/O interface for corresponding functional blocks of the network accelerator 102. With respect to interface I/O fields listed in the table 600, the RMW manager 136 or the statistics block 116 is the initiator, and the data memory 120 is the target. Accordingly, the interface I/O fields listed in the table 600 are issued by the RMW manager 136 or the statistics block 116 to be executed by the data memory 120 (for example, by a memory controller of the data memory 120). In some examples, RMW initiator interface I/O fields described with respect to the table 600 are used by the RMW manager 136 to generate read requests to retrieve a statistics value to be updated from the data memory 120, or to generate write requests (write transactions) to write an updated statistics value to the data memory 120.

A first column 602 indicates an example interface I/O field name, a second column 604 indicates an input or output direction, a third column 606 indicates an example interface I/O field bit width, and a fourth column 608 provides a description of the corresponding interface I/O field. A req field relates to output, has a bit width of one, and indicates an interface bus request. A dir field relates to output, has a bit width of one, and indicates an interface bus direction. In an example, a zero indicates a write, and a one indicates a read. An address field relates to output, has a bit width of eight, and indicates an interface bus address. A byten field relates to output, has a bit width of eight, and indicates an interface bus byte enable. A wdata field relates to output, has a bit width of 64, and indicates interface bus write data. A wready field relates to input, has a bit width of one, and indicates interface bus write ready. An rdatap field relates to input, has a bit width of 64, and indicates interface bus read data. An rready field relates to input, has a bit width of one, and indicates interface bus read ready.

As described above, use of the RMW manager 136 of FIG. 2 enables maintaining coherency when there are updates requested to a statistics value by multiple different users at the same time. The RMW manager 136 maintains time-ordering of statistics updates so that a correct value is written at write time. It does so by controlling a single statistics update data memory 120 access to be performed at a time, and by time-ordering such accesses.

In some examples, an integrated circuit other than an SoC includes an RMW manager such as the RMW manager 136.

In some examples, a functional block other than a network accelerator 102 includes an RMW manager such as the RMW manager 136.

In some examples, a processor is a central processing unit (CPU), a digital signal processor (DSP), or a microcontroller unit (MCU).

In some examples, processes described herein can be implemented as hardware, software, or a combination thereof.

In some examples, the status bit is set to INVALID when there is a write to the read FIFO memory 222 location indicated by the tail pointer 228. In some examples, the status bit is set to INVALID when the ADD value and memory pointer are read from the read FIFO memory 222 location indicated by the head pointer 224 to be provided to the arithmetic pipeline 212.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or IC package) and may be adapted to be coupled to at least some of the passive elements and/or the sources to form the described structure either at a time of manufacture or after a time of manufacture, for example, by an end-user and/or a third-party.

The techniques described in this disclosure may also be embodied or encoded in an article of manufacture including a non-transitory computer-readable storage medium. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a silicon germanium (SiGe) substrate, a gallium nitride substrate (GaN) or a gallium arsenide substrate (GaAs).

Circuits described herein may be reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples may be included in an IC and other elements are external to the IC, in other example embodiments, additional or fewer features may be incorporated into the IC. In addition, some or all of the features illustrated as being external to the IC may be included in the IC and/or some features illustrated as being internal to the IC may be incorporated outside of the IC. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

While this disclosure has been described with reference to illustrative embodiments, this description is not limiting. Various modifications and combinations of the illustrative embodiments, as well as other embodiments, will be apparent to persons skilled in the art upon reference to the description.

Modifications are possible in the described examples, and other examples are possible, within the scope of the claims.

What is claimed is:

1. A device comprising:
a first memory;
a second memory;
an arithmetic pipeline coupled to the first memory;
a write pipeline coupled to the arithmetic pipeline; and
a controller coupled to the arithmetic pipeline and the write pipeline, wherein:
the first memory is configured to:
receive a first value and a first indicator of a memory location of the second memory;
store the first value and the first indicator;
receive a first read value associated with the memory location; and
store the first read value;
the arithmetic pipeline is configured to perform an arithmetic operation on the first value and the first read value to produce a first result; and
the write pipeline is configured to store the first result in the second memory.

2. The device of claim 1,
wherein the controller is configured to maintain a first pointer indicating a first memory location of the first memory, a second pointer indicating a second memory location of the first memory, and a third pointer indicating a third memory location of the first memory;
wherein the first memory is configured to store the first value and the first indicator at the first memory location, and the controller is configured to responsively increment the first pointer;
wherein the first memory is configured to store the first read value at the second memory location, and the controller is configured to responsively increment the second pointer; and
wherein the first memory is configured to read the first value and the first read value from the third memory location and to provide the first value and the first read value to the arithmetic pipeline, and the controller is configured to responsively increment the third pointer.

3. The device of claim 1, further comprising:
a third memory; and
a decoding circuit;
wherein the decoding circuit is configured to:
receive, in a message, either the first value, or the first indicator, or both;
responsive to receiving both the first value and the first indicator in the message, provide the first value and the first indicator to the first memory; and
responsive to receiving one of the first value or the first indicator in the message, provide the received one of the first value or the first indicator to the third memory.

4. The device of claim 3, wherein the third memory is configured to provide the first value and the first indicator to the first memory responsive to the third memory storing both the first value and the first indicator.

5. The device of claim 1,
wherein a value or a result, and a corresponding indicator of a location in the second memory, together correspond to an update request; and
wherein a first pending update request is not stalled responsive to a second pending update request if the first memory is not full.

6. The device of claim 1,
further comprising a data forwarding block;
wherein the first memory, the arithmetic pipeline, and the write pipeline are configured to provide indicators to the data forwarding block;
wherein the data forwarding block is configured to compare an indicator provided from a memory location of the first memory to the indicator provided from the arithmetic pipeline or the write pipeline to determine whether there is a matching indicator;
wherein the data forwarding block is configured to, responsive to the matching indicator, provide a read value or result corresponding to the matching indicator to the first memory; and
wherein the first memory is configured to store the corresponding read value or corresponding result in the memory location of the first memory.

7. The device of claim 6, wherein the controller is configured to invalidate a write transaction corresponding to the matching indicator.

8. The device of claim 1, wherein the first memory is configured to be circularly addressed.

9. A device comprising:
a first memory configured to store instructions;
a processor coupled to the first memory, configured to execute the instructions, and configured to provide a first update request that includes a first value and a first indicator of a memory location of the first memory; and
a read-modify-write (RMW) manager that includes:
a second memory;
an arithmetic pipeline;
a write pipeline; and
a controller configured to:
control the second memory to receive the first update request, and to store the first update request in the second memory;
cause a first read value to be read from the first memory based on the first indicator and stored in the second memory;
cause the arithmetic pipeline to perform an operation on the first value and the first read value to produce a first result; and
cause the write pipeline to store the first result in the first memory.

10. The device of claim 9,
wherein the controller is configured to maintain a first pointer indicating a first memory location of the second memory, a second pointer indicating a second memory location of the second memory, and a third pointer indicating a third memory location of the second memory;
wherein the second memory is configured to store the first value and the first indicator at the first memory location, and the controller is configured to responsively increment the first pointer;
wherein the second memory is configured to store the first read value at the second memory location, and the controller is configured to responsively increment the second pointer; and
wherein the second memory is configured to read the first value and the first read value from the third memory location and to provide the first value and the first read value to the arithmetic pipeline, and the controller is configured to responsively increment the third pointer.

11. The device of claim 9, further comprising:
a third memory; and
a decoding circuit;
wherein the decoding circuit is configured to:
receive in a message either the first value, or the first indicator, or both;
responsive to receiving both the first value and the first indicator in the message, provide the first value and the first indicator to the second memory; and
responsive to receiving one of the first value or the first indicator in the message, provide the received one of the first value or the first indicator to the third memory.

12. The device of claim 11,
wherein the message includes an identifier of the processor; and
wherein the third memory is configured to store the first value or the first indicator in a memory location of the third memory corresponding to the identifier.

13. The device of claim 11, wherein the third memory is configured to provide the first value and the first indicator to the second memory responsive to the third memory storing both the first value and the first indicator.

14. The device of claim 9, wherein the first update request is not stalled responsive to a second pending update received by the second memory.

15. The device of claim 9,
further comprising a data forwarding block;
wherein the second memory, the arithmetic pipeline, and the write pipeline are configured to provide indicators to the data forwarding block;
wherein the data forwarding block is configured to compare an indicator provided from a memory location of the second memory to an indicator provided from the arithmetic pipeline or the write pipeline to determine whether there is a matching indicator;
wherein the data forwarding block is configured to, responsive to the matching indicator, provide a read value or result corresponding to the matching indicator to the second memory; and
wherein the second memory is configured to store the corresponding read value or corresponding result in the memory location of the second memory.

16. The device of claim 15, wherein the controller is configured to invalidate a write transaction that includes the matching indicator.

17. The device of claim 9, wherein the second memory is configured to be circularly addressed.

18. A method comprising:
receiving, by a first memory, a first value and a first indicator of a memory location of the second memory;
storing the first value and the first indicator in the first memory;
providing the first indicator from the first memory to a second memory;
receiving from the second memory, by the first memory, a first read value responsive to the first indicator;
storing the first read value in the first memory;
providing the first value and the first read value from the first memory to an arithmetic pipeline;
performing an arithmetic operation on the first value and the first read value, by the arithmetic pipeline, to generate a result; and
storing the result in the second memory responsive to the first indicator.

19. The method of claim 18, further comprising:
wherein storing the first value and the first indicator in the first memory is responsive to a first pointer to a first memory location of the first memory, responsively incrementing the first pointer;
wherein providing the first indicator from the first memory to the second memory is responsive to a second pointer to a second memory location of the first memory, incrementing the second pointer responsive to the first memory receiving the first read value; and
wherein providing the first value and the first read value from the first memory to the arithmetic pipeline is responsive to a third pointer to a third memory location of the first memory, responsively incrementing the third pointer.

20. The method of claim 19, wherein the storing is performed responsive to the arithmetic pipeline providing the result and the first indicator to a write pipeline, the method further comprising:
providing indicators from the first memory, the arithmetic pipeline, and a write pipeline to a data forwarding block;
comparing, by the data forwarding block, an indicator provided from a memory location of the first memory to the indicator provided from the arithmetic pipeline or the write pipeline to determine whether there is a matching indicator;
responsive to the matching indicator, providing a read value or result corresponding to the matching indicator to the first memory; and
storing, by the first memory, the corresponding read value or corresponding result in the memory location of the first memory.
